(19) United States
(12) Patent Application Publication
(10) Pub. No.: US 2026/0357842 A1
(43) Pub. Date: Nov. 12, 2026

(54) LOAD DETECTION SYSTEM

(71) Applicant: Dash LLC, Murray, UT (US)

(72) Inventors: Daniel J. Steed, Murray, UT (US); Jeremy Fairbourne, Syracuse, UT (US)

(21) Appl. No.: 19/201,459

(22) Filed: May 7, 2025

(51) Int. Cl. F16B 31/02; B25B 21/02; G01L 1/22; G01L 5/24

(52) U.S. Cl. CPC F16B 31/025; B25B 21/02; G01L 1/22; G01L 5/24; F16B 2031/022; F16B 31/028

(57) ABSTRACT

A load detection system includes a fastener assembly that has a load detector configured to detect a load applied to a shank of a fastener of the fastener assembly. The load detection system further includes a shut-off device that is communicatively coupled to the load detector of the fastener. The shut-off device is configured to shut off power to an impact wrench configured to tighten the fastener.

### TECHNICAL FIELD

This disclosure relates generally to fasteners and the tightening of fasteners. More specifically, this disclosure relates to load detection systems for tightening fasteners to a predetermined tightness with an impact wrench.

### BACKGROUND

Impact wrenches and torque wrenches are tools that are commonly used in automotive, construction, and industrial applications. Impact wrenches are power tools that are designed to deliver high torque output with minimal exertion by the user. They operate using a hammering mechanism that generates sudden, high-torque impacts to drive fasteners quickly and efficiently. Impact wrenches are commonly powered by compressed air (pneumatic), electricity (corded or cordless), or hydraulics. They may be useful in situations requiring the rapid removal or installation of large or stubborn fasteners, making them a staple in automotive repair shops, manufacturing plants, and construction sites.

Torque wrenches, on the other hand, are precision tools designed to apply a specific amount of torque to a fastener, ensuring that it is neither too loose nor too tight. Torque wrenches may be used in applications where the integrity of the assembly depends on accurate torque values, such as in the assembly of engines, aerospace systems, and complex structures (e.g., buildings, bridges, or tunnels). Torque wrenches come in various types, including click type, beam type, digital, and dial type, each offering different methods of measuring and applying torque.

### BRIEF SUMMARY

According to some aspects of the disclosure, a load detection system includes a fastener assembly that has a load detector configured to detect a load applied to a shank of a fastener of the fastener assembly. The load detection system further includes a shut-off device that is communicatively coupled to the load detector of the fastener. The shut-off device is configured to shut off power to an impact wrench configured to tighten the fastener.

In one aspect, a method for tightening a fastener is provided. The method includes communicatively coupling a load detector positioned within a fastener assembly to a shut-off device. A fastener of the fastener assembly is tightened with an impact wrench, and a load on the fastener is monitored with the load detector of the fastener. Power to the impact wrench is shut off via the shut-off device when the monitored load is at or exceeds a predetermined threshold load.

In one aspect, a load detecting fastener includes a sensor configured to measure a load on a shank of the fastener and an integrated circuit configured to receive an output of the sensor. The fastener further includes a transceiver operable to output information based on the output of the sensor.

### BRIEF DESCRIPTION OF THE DRAWINGS

For a detailed understanding of the disclosure, reference should be made to the following detailed description, taken in conjunction with the accompanying drawings, in which like elements have generally been designated with like numerals.

To easily identify the discussion of any particular element or act, the most significant digit or digits in a reference number refer to the figure number in which that element is first introduced.

FIG. 1 shows a schematic view of a load detection system according to embodiments of the disclosure.

FIG. 2 shows a schematic view of a load detection system according to embodiments of the disclosure.

FIG. 3A shows a side view of a fastener that includes a load detector according to embodiments of the disclosure, and FIG. 3B is a schematic section view taken along the line A-A in FIG. 3A.

FIG. 4A shows a socket on which a relay device may be incorporated; FIG. 4B, shows a relay device; and FIG. 4C shows the relay device of FIG. 4B installed on the socket of FIG. 4A.

FIG. 5 shows a method of tightening a fastener according to embodiments of the disclosure.

FIG. 6 shows a method of monitoring a load on a fastener according to embodiments of the disclosure.

FIG. 7 shows a fastener assembly for use in a load detection system according to embodiments of the disclosure.

### DETAILED DESCRIPTION

The illustrations presented herein are not actual views of any load detection system, fastener, or any component thereof, but are merely idealized representations, which are employed to describe embodiments of the disclosure.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any load detection system, fastener, or any component thereof when utilized in a conventional manner. Furthermore, these terms may refer to an orientation of elements of any load detection system, fastener, or any component thereof as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

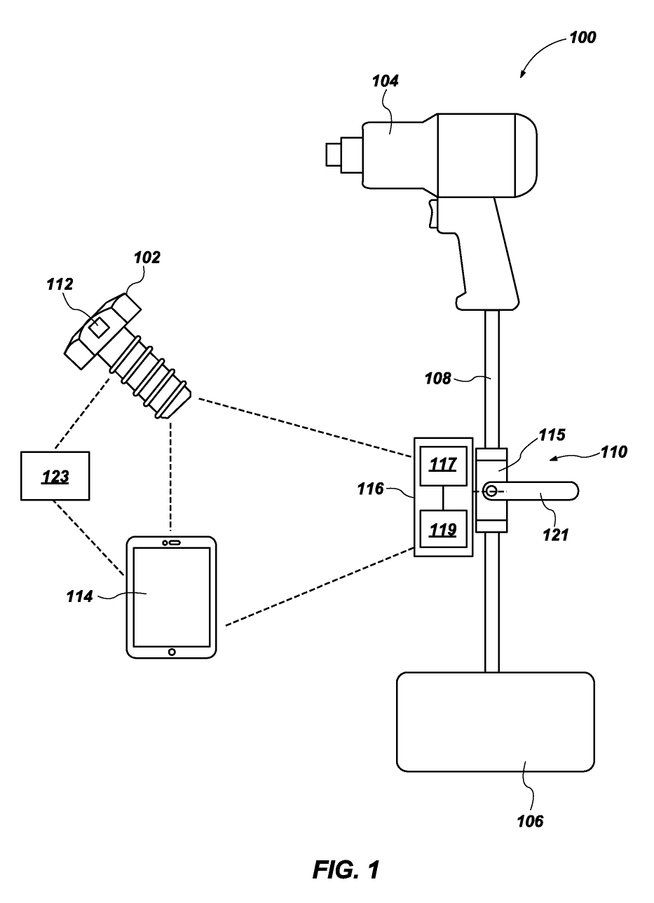

FIG. 1 shows a schematic view of a load detection system 100 according to embodiments of the disclosure. The load detection system 100 is configured to detect a load applied to one or more fasteners 102 to determine whether the fasteners 102 are torqued to a predetermined tightness for a given application. The detected load on the one or more fasteners 102 caused by torquing or tightening the fasteners 102, or by torquing or tightening a nut threaded onto the fasteners 102, is often referred to as, e.g., a preload, a pretension, or a clamp force applied to one or more fasteners 102. The fasteners 102 may be any of a variety of fasteners, including various types of bolts, studs, screws, etc.

The load detection system 100 may further comprise an impact wrench 104. The impact wrench 104 may be any suitable impact wrench 104 that utilizes compressed air from a compressed air supply 106 to power the impact wrench 104. The compressed air may be delivered to the impact wrench 104 via a compressed air line 108.

The load detection system 100 may comprise a valve assembly 110 disposed along the compressed air line 108. The valve assembly 110 may be configured to control the supply of air from the compressed air supply 106 to the impact wrench 104. In one embodiment, the valve assembly 110 may comprise a valve 115, such as a ball valve. By controlling the supply of air to the impact wrench 104, power to the impact wrench 104 may be controlled, such as to provide or to shut off power to the impact wrench 104. The valve assembly 110 may thus be considered a shut-off device for shutting off power to the impact wrench 104. The valve assembly 110 is shown as being disposed on the compressed air line 108 at an intermediate position between the compressed air supply 106 and the impact wrench 104. However, the valve assembly 110 may be disposed adjacent to or may be integrated with (e.g., formed as a component part of) the compressed air supply 106 or the impact wrench 104.

In applications where a fastener should be tightened to a specific torque, an operator typically uses a torque wrench to ensure that the specified torque is applied to the fastener. A torque wrench is a manually operated tool that requires time and effort from an operator when used correctly. This can add time to a project and increase operator fatigue during the project. Furthermore, use of a torque wrench introduces pinch points which may be hazardous to an operator during operation. In some instances, an operator will use an impact wrench to tighten a fastener, and thereafter use a torque wrench to ensure a correctly applied torque to the fastener. However, the use of two tools to tighten a fastener increases time for a project or may result in improperly torqued fasteners.

In the load detection system 100, the fasteners 102 may each include a load detector 112. The load detector 112 may be configured to measure a load experienced by the fastener 102 (e.g., a preload, a pretension, or clamp force), such as by measuring a strain experienced by the fastener, when the fastener 102 is tightened in a given application. The load detector 112 may comprise a wireless communication transceiver that is configured to output the measured load to an external device. For example, the load detection system 100 may comprise a computing device 114, such as a mobile computing device (e.g., a mobile phone), a handheld electronic device (e.g., a tablet), a computer (e.g., a laptop or desktop personal computer), or the like. The computing device 114 may be configured to communicatively couple to the load detector 112 of the fastener 102 to receive information from the load detector 112 regarding the load experienced by the fastener 102.

The valve assembly 110 may comprise a valve controller 116 that is configured to control a state of the valve 115. The valve controller 116 may comprise an electronic control unit (“ECU”) 117 and a wireless communication transceiver 119. The ECU may comprise a processor, memory, a power source, and associated circuitry that is operable to control the valve assembly 110. The wireless communication transceiver 119 may be configured to receive a wireless signal from the computing device 114. The valve assembly may further comprise an actuator 121 communicatively coupled to the valve controller 116 that is operable to open and close the valve 115. For example, the valve controller 116 may send a signal to the actuator 121 to actuate the valve 115 to allow or restrict air flow from the compressed air supply 106 to the impact wrench 104.

The computing device 114 may monitor a signal from the load detector 112 of the fastener 102 to monitor a load experienced by the fastener 102, such as when the fastener 102 is being torqued by the impact wrench 104. The computing device 114 may be programmed to monitor the load experienced by the fastener 102 to determine whether the load experienced by the fastener 102 meets or exceeds a predetermined threshold load. A predetermined threshold load may be set according to a specification for a given application (e.g., the predetermined threshold load may be a measured load that corresponds to a required torque or tightness for a fastener in a given application). The computing device 114 may send a signal to the valve controller 116 of the valve assembly 110 to cause the valve controller 116 to actuate the valve 115 based on the received signal from the load detector 112. In some embodiments, the computing device 114 may provide an alert to a user (e.g., an audible or visible alert) based on the received signal from the load detector 112.

For example, while monitoring the signal from the load detector 112 of the fastener 102, the computing device 114 may determine that the signal from the load detector 112 indicates that the current load experienced by the fastener 102 has reached or exceeded the predetermined threshold load. The predetermined threshold load may correspond to a required torque based on a specification for a given application. The computing device 114 may then send a signal to the valve controller 116 of the valve assembly 110 such that the valve controller 116 controls the actuator 121 to actuate the valve 115 to restrict airflow through the compressed air line 108, cutting off air pressure to the impact wrench 104, thereby stopping the impact wrench 104 from continuing to apply a torque to the fastener 102.

In some embodiments, the load detection system 100 may omit the computing device 114. The load detector 112 of the fastener 102 may be configured to communicatively couple to the valve controller 116 of the valve assembly 110 and send a load indication directly to the valve controller 116. The valve controller 116 may be programmed to monitor the signal from the load detection system 100 to determine when the load indication meets or exceeds a predetermined threshold load. The valve controller 116 may be programmed to cause the actuator 121 to actuate the valve 115 based on the information received from the load detector 112 of the fastener 102, such as when the load experienced by the fastener 102 meets or exceeds the predetermined threshold load.

In some embodiments, the computing device 114 may be incorporated into another one of the components of the load detection system 100. For example, the computing device 114 may be incorporated into the impact wrench 104 such that impact wrench 104 communicatively couples to the load detector 112 of the fastener 102 to receive information from the load detector 112 regarding a load experienced by the fastener 102 based on the tightening of the fastener 102.

In some embodiments, the load detection system 100 may comprise a relay device 123. For example, when a socket is placed over a head of the fastener 102, the socket may prevent transmission of a wireless signal from the load detector 112 of the fastener 102 to the computing device 114 or to the valve controller 116. The relay device 123 may be configured to detect the wireless signal from the load detector 112 of the fastener 102 and to relay the wireless signal from, for example, within the socket to outside of the socket. In some embodiments, the relay device 123 may comprise an internal antenna built into the socket that is configured to detect the wireless signal from the load detector 112 and an external antenna connected to the internal antenna that is configured to transmit the wireless signal to the computing device 114 and/or the valve controller 116.

In some embodiments, the relay device 123 provides a wired connection between the load detector 112 of the fastener 102 and the computing device 114 and/or the valve controller 116. For example, the relay device 123 may comprise a contact that is incorporated into a socket. The contact may electrically couple with a contact of the load detector 112 of the fastener 102. The relay device 123, through a wired connection, may then relay a signal from the load detector 112 to the computing device 114 and/or valve controller 116, such as by way of the impact wrench 104.

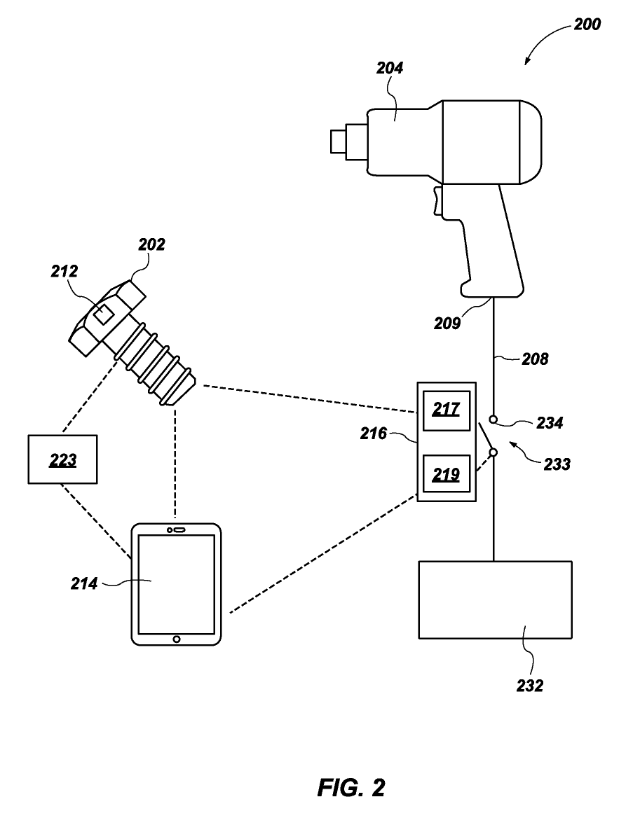

FIG. 2 shows a schematic view of a load detection system 200 in accordance with embodiments of the disclosure. To avoid repetition, not all features (e.g., devices, components) shown in FIG. 2 are described in detail herein. Rather, unless described otherwise below, in FIG. 2, a feature designated by a reference numeral that is a 100 increment of the reference numeral of a feature previously described with reference to FIG. 1 will be understood to be substantially similar to the previously described feature. By way of non-limiting example, unless described otherwise below, features designated by the reference numerals 212, 214 in FIG. 2 respectively will be understood to be substantially similar to the load detector 112 and the computing device 114 previously described herein with reference to FIG. 1.

In the load detection system 200 shown in FIG. 2, the impact wrench 204 may be an electric impact wrench rather than a pneumatic impact wrench. The impact wrench 204 may be connected, via an electrical connection 208 (e.g., one or more electrical cables), to an electrical power source 232, such as a battery, which provides power for the operation of the impact wrench 204. A switch assembly 233 is positioned between the impact wrench 204 and the power source 232 on the electrical connection 208 (e.g., on an electrical cable or inserted between electrical cables) or on the impact wrench 204 (e.g., at or near an electrical connector 209 of the impact wrench 204). The switch assembly 233 may be communicatively coupled to the computing device 214 or the load detector 212 of the fastener 202 to shut off power to the impact wrench 204 when the load detector 212 detects a load experienced by the fastener 202 at or above a predetermined threshold. The switch assembly 233 may thus be considered a shut-off device for shutting off power to the impact wrench 204.

The switch assembly 233 may comprise an electrical switch 234 and switch controller 216 that is configured to control a state of the switch 234. The switch controller 216 may comprise an electronic control unit (“ECU”) 217 and a wireless communication transceiver 219. The ECU may comprise a processor, memory, a power source, and associated circuitry that is operable to control the switch assembly 233. The wireless communication transceiver 219 may be configured to receive a wireless signal from the computing device 214. Similar to the valve controller 116, the switch controller 216 may send a signal to change a state of the switch 234 to allow or restrict electrical power from the electrical power source 232 to the impact wrench 204. In some embodiments, the switch assembly 233 may be integrated into the impact wrench 204 and/or the power source 232 (e.g., battery).

The load detection system 100, 200 may thus monitor the load experienced by the fastener 102, 202 as a result of being tightened by the impact wrench 104, 204. Furthermore, the load detection system 100, 200 may restrict power to the impact wrench 104, 204 based on the monitored load. This may allow a user to tighten the fastener 102, 202 to a predetermined threshold load corresponding to a predetermined torque using the load detection system 100, 200 without the need to alternatively or additionally use a torque wrench. This helps to save the time and effort and to increase safety of an operator tightening the fastener 102, 202.

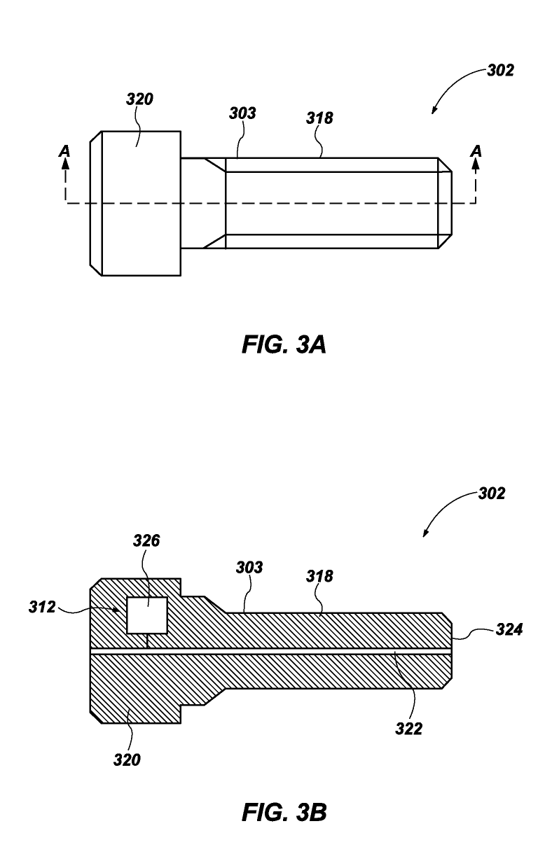

FIG. 3A shows a side view of a fastener of a load detection system and FIG. 3B shows a schematic section view of the fastener in FIG. 3A taken along the line A-A. The fastener 302 may be similar to the fasteners 102, 202 shown in FIGS. 1 and 2. The fastener 302 may comprise a body 303 and a load detector 312. The body 303 may include a threaded shank 318 and a head 320. The load detector 312 may be the same or similar to load detectors 112, 212.

In various embodiments, the load detector 312 is positioned within the body 303 (e.g., within the threaded shank 318). The load detector 312 may comprise a sensor 322 configured to measure a load applied to the fastener 102 resulting from tightening the fastener 302 in a given application. For example, the sensor 322 may be a strain gauge that is configured to sense the strain experienced by the fastener (e.g., the strain within the shank 318 of the fastener). The strain gauge may be configured to seat on a distal end 324 of the shank 318 and extend through the shank 318 to a position on or within the head 320, which may ensure strain is measured along the entire shank 318 of the fastener 302. For example, the sensor 322 (e.g., strain gauge) may extend completely through the fastener 302 (e.g., from the distal end 324 to a proximal end of the head 320) along or parallel to a longitudinal axis thereof. In some embodiments, a sensor 322 may be configured as a strain gauge extending the length of the fastener 302. The strain gauge may be connected at its first end to the distal end 324 of the fastener 302 via an epoxy, solder, or other joining method, and may be seated at its second end on the head 320 of the fastener 302. The load detector 312 may further comprise an integrated circuit 326. The sensor 322 may be connected to or otherwise communicatively coupled to the integrated circuit 326.

The integrated circuit 326 may be configured to obtain a reading from the sensor 322 (e.g., a resistance of the strain gauge). The integrated circuit 326 may comprise a wired or wireless transceiver configured to communicatively couple to an external component, such as the computing device 114, 214 or the valve assembly 110 or switch assembly 233 (see FIGS. 1 and 2). For example, the integrated circuit 326 may comprise one or more of a BLUETOOTH™, a Near Field Communication (“NFC”), or a Radio-Frequency Identification (“RFID”) chip that communicatively couples to the external component when the external component is brought within a predetermined proximity of the fastener 302. An NFC reader from the external device may be configured to read information from the integrated circuit 326, including a reading from the sensor 322. In some examples, the integrated circuit 326 may utilize other wireless communication protocols to communicatively couple with the external component such as via BLUETOOTH™, Wi-Fi, or other wireless communication protocol. The integrated circuit 326 may communicatively couple to the external device via a pairing operation. In some embodiments, the integrated circuit 326 may connect to the external device via a network such as a wireless PAN, LAN, WAN, etc. In some embodiments, the integrated circuit 326 may connect via a physical electrical contact with an external device and may send a signal over a wired connection.

The integrated circuit 326 may be a passive device that is activated in the presence of an NFC or RFID reader or may be an active device. In some embodiments, the load detector 312 may comprise a power source, such as a battery, to provide power to the integrated circuit 326. The integrated circuit 326 may comprise an antenna to facilitate communications with the external device.

When the load detector 312 is communicatively coupled to the external device via the integrated circuit 326, the load detector 312 may be configured to transmit information based on a reading from the sensor 322. The information may be indicative of a strain within the shank 318 of the fastener 302 that corresponds to a load on the fastener 302 caused by tightening the fastener 302 in a given application.

In some embodiments, the sensor 322 of the load detector 312 may comprise a different sensor instead of or in addition to a strain gauge. For example, the sensor 322 may comprise a non-destructive ultrasonic detector. The ultrasonic detector may be attached to or embedded within the fastener 302, such as on the head 320, and may be connected to the integrated circuit 326. The ultrasonic detector may be configured to detect a change in length or a change in other properties of the fastener 302 during tightening which may correspond to a load applied to the fastener 302 during tightening.

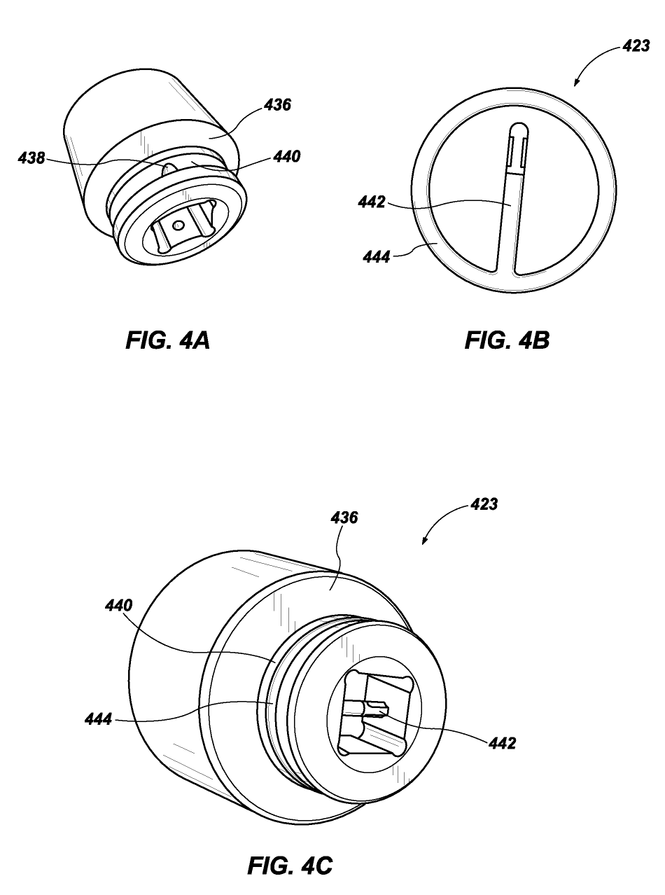

FIG. 4A shows a socket 436 on which a relay device may be incorporated; FIG. 4B, shows a relay device 123; and FIG. 4C shows the relay device 123 of FIG. 4B installed on the socket 436 of FIG. 4A. As shown in FIG. 4A, a socket 436 may comprise a through hole 438 within a groove 440 that is located on a proximal end 446 of the socket 436. The groove 440 and through hole 438 may be utilized to attach a relay device 423 to the socket 436. The relay device 423 may be similar to relay device 123 discussed above.

As shown in FIG. 4B, the relay device 423 may comprise an internal antenna 442 configured to be positioned within an interior of the socket 436, The relay device 423 may also comprise an external antenna 444 configured to be positioned on an exterior of the socket 436. Similar to relay device 123 discussed above, the internal antenna 442 of the relay device 423 may be configured to detect a signal within the socket 436, such as from a load detector 112, 212, 312, and transmit the signal to the external antenna 444 such that the signal may be relayed to another device. The relay device 423 may installed onto the socket 436 by threading the internal antenna 442 through the through hole 438 and positioning the external antenna 444 in the groove 440 as shown in FIG. 4C.

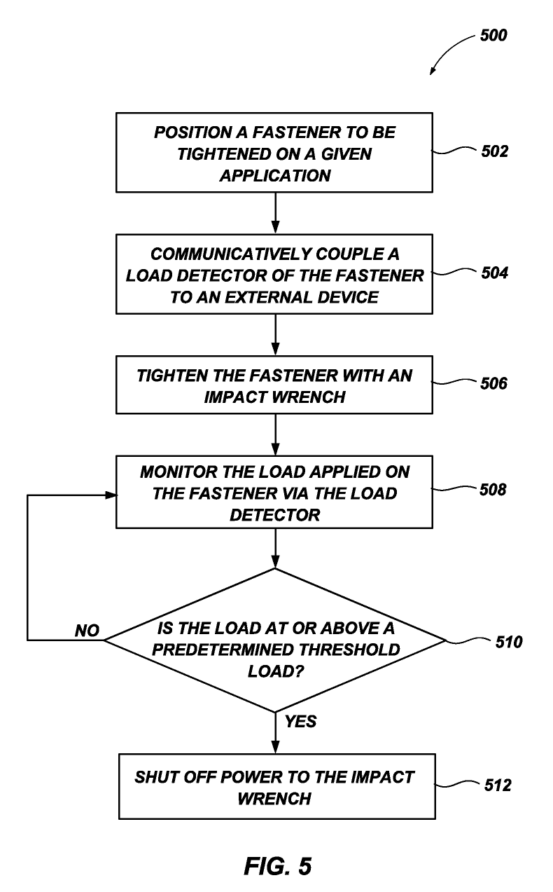

FIG. 5 shows a method 500 of tightening a fastener according to embodiments of the disclosure. The method 500 may be performed utilizing the load detection system 100, 200 and fasteners 102, 202, 302. In step 502, an operator positions a fastener to be tightened onto a given application. For example, an operator may hand tighten a fastener into a threaded hole on a given application, or the operator may hand tighten a nut onto the fastener to install the fastener in a predetermined position for a given application.

In step 504, a load detector of the fastener may be communicatively coupled to an external device. For example, if the external device is a computing device (e.g., computing device 114, 214), the computing device may be brought into close proximity with the fastener to communicatively couple to the load detector (e.g., load detector 112, 212, 312) of the fastener via a wireless communication protocol such as NFC or RFID. The computing device may also or alternatively communicatively couple to the load detector of the fastener via other wireless protocols such as BLUETOOTH™, Wi-Fi, ZIGBEE™, etc. The computing device may communicatively couple to the load detector via a network such as a wireless PAN, LAN, WAN, etc. The external device could be another device in addition to or instead of the computing device. For example, the external device may be a switch (e.g., switch 234), a valve controller (e.g., valve controller 116), or the like.

It is noted that step 502 and step 504 may be completed in either order. For example, the load detector of the fastener may be communicatively coupled to the external device prior to the fastener being positioned on a given application.

In step 506, an operator tightens the fastener with an impact wrench. For example, the operator may utilize a pneumatic impact wrench (e.g., impact wrench 104) or an electric impact wrench (e.g., impact wrench 204) to apply a torque on the fastener to tighten the fastener in place.

In step 508, the load applied on the fastener as a result of the tightening is monitored via the load detector of the fastener. For example, the load detector may transmit information to the external device (e.g., the computing device) based on a reading from a strain gauge within the fastener. The reading of the strain gauge may correspond to the load applied on the fastener as a result of tightening the fastener, and may correspond to a torque applied to the fastener as a result of tightening the fastener.

In step 510, it is determined whether the monitored load is at or above a predetermined threshold load. For example, the computing device or other external device (e.g., the shut-off device) may compare the information received from the load detector of the fastener to the predetermined threshold load. The predetermined threshold load may correspond to an applied torque on the fastener that is based on a specification for a given application in which the fastener is being used. The predetermined threshold load may be programmed into the computing device or other external device manually by a user or may be based on a data source (e.g., a specification read by the computing device, an identification of a fastener to be torqued, etc.). If it is determined that the load is not at or above the predetermined threshold load, then the method returns to step 508 and the load continues to be monitored. When it is determined that the load is at or above the predetermined threshold load, the method proceeds to step 512.

Once it is determined that load on the fastener is at or above the predetermined threshold load, power is shut off to the impact wrench in step 512, such that the impact wrench does not apply any more torque to the fastener. For example, the computing device may send a signal to the valve controller to close the valve to restrict air flow from the compressed air supply to the torque wrench, thereby cutting off power to the impact wrench. In another example, the computing device may send a signal to a switch to open a circuit providing power to the impact wrench, thereby cutting off power to the impact wrench. In some examples, the load detector may send the signal directly to the valve controller or switch or may send the signal via a wireless network.

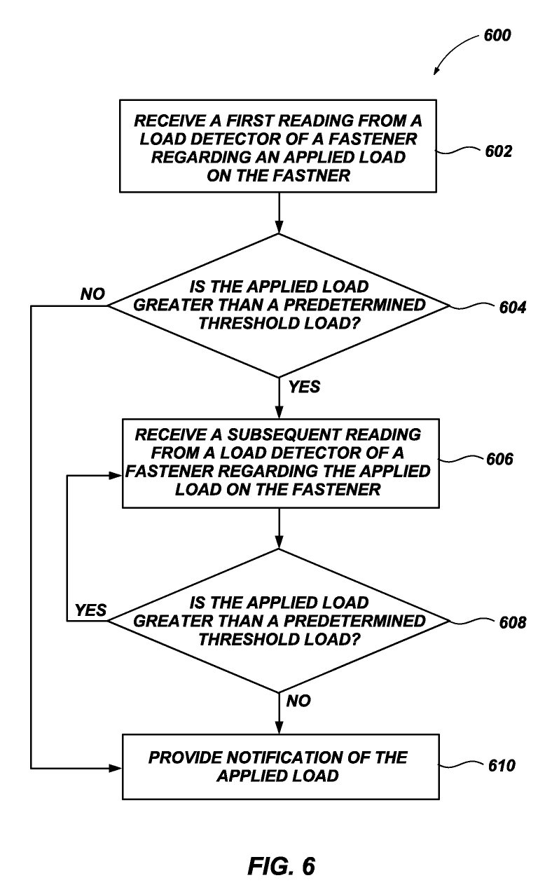

In some embodiments, a load detection system (e.g., load detection system 100, 200) is used not only to ensure that fasteners are tightened to a predetermined threshold load, but also may be used to monitor the load on the fasteners over an extended time. FIG. 6 shows a method 600 of monitoring a load on a fastener according to embodiments of the disclosure. The method 600 may be performed utilizing the load detection system 100, 200 and fasteners 102, 202, 302 described above. In step 602, a first reading from a load detector of a fastener is received regarding an applied load on the fastener. For example, a sensor (e.g., sensor 322) of a load detector (e.g., load detector 112, 212) may sense one or more properties of the fastener (e.g., strain) that is associated with a load applied to the fastener. The load detector may send a signal via a wired or wireless network which is received at a computing device (e.g., computing device 114, 214).

In step 604, it is determined whether the applied load received in step 602 is greater than a predetermined threshold load. For example, the computing device that received the signal from the load detector may compare a value of the load detected by the sensor with a predetermined threshold load. If the value is greater than the predetermined threshold load, then the computing device may determine that the fastener is still sufficiently tight, and the method may proceed to step 606. If the value is less than the predetermined threshold load, then the method may proceed to step 610.

In step 606, a load detection system may continue to monitor the load on the fastener by receiving a subsequent reading from a load detector regarding the applied load on the fastener. In step 608, if the applied load remains greater than the predetermined threshold load, the method returns to step 606 to continue to monitor the load on the fastener. If the applied load falls below the predetermined threshold load, the method proceeds to step 610.

In step 610, when it is determined that the applied load is below the predetermined threshold load, in step 604 or step 608, a notification may be provided concerning the status of the applied load on the fastener. For example, the computing device may output message on an output device, such as a display screen, a speaker, etc. The output message may communicate to a user that the load applied on the fastener is below the predetermined threshold level, which may indicate that the bolt has loosened, has become damaged, or the like.

In the method 600, the load detector may continuously or regularly send a signal which may be received by the computing device. For example, the load detector may be connected to a network via a wireless protocol (Wi-Fi, Bluetooth, etc.) to provide continuous or regular signals to the computing device. In some examples, a user periodically or occasionally monitors the fasteners, such as by bringing the computing device to within a proximity of the fastener to activate an NFC or RFID tag of the load detector of the fastener to receive the signal from the load detector.

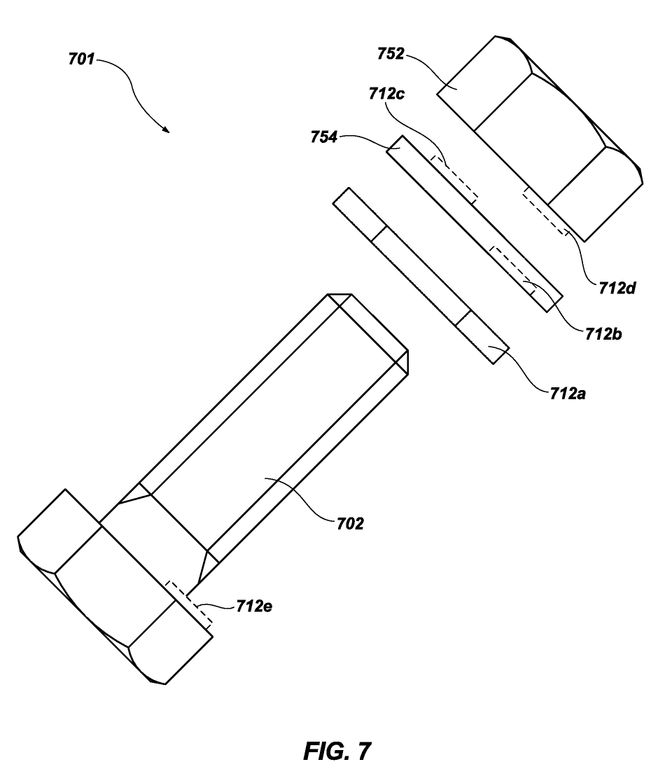

In the embodiments described above, a load detector (e.g., load detector 112, 212, 312) is described as being disposed on or in the fastener (e.g., fastener 102, 202, 302). However, a load detector may be located at other positions to measure a load applied to the fastener. FIG. 7 shows a fastener assembly 701 for use in a load detection system according to embodiments of the present disclosure. The fastener assembly 701 may comprise a fastener 702. The fastener 702 may be similar to fasteners 102, 202, 302 discussed above. The fastener assembly 701 may further include at least one washer 754 and a nut 752. The fastener assembly 701 may include other components as are known in the art (e.g., seals, lock washers, etc.).

At least one load detector 712a, 712b, 712c, 712d, 712e may be incorporated into the fastener assembly 701 to measure a load corresponding to the a load on the fastener 702 as a result of tightening the fastener. The load detectors 712a, 712b, 712c, 712d, 712e are shown in broken line to indicate one or more optional positions for the load detectors 712a, 712b, 712c, 712d, 712e within the fastener assembly 701.

For example, a load detector 712a may be provided and shaped as an additional washer or seal. The load detector 712a is placed between other components of the fastener assembly 701 and/or objects to be fastened. The load detector 712a may comprise a load sensor such as load cell or other pressure or compression sensor. As the fastener 702 is tightened, the force detected by the load detector 712a may be correlated to the load (e.g., a preload, a pretension, or a clamp force) applied to the fastener 702.

As another example, a load detector 712b may be incorporated within the washer 754 of the fastener assembly. In addition or as an alternative, a load detector 712c may be disposed on a surface of the washer 754. In addition or as an alternative, a load detector 712d may be disposed on a surface of the nut 752. In addition or as an alternative, a load detector 712e may be disposed on a surface of a head of the fastener 702. The load detectors 712b, 712c may operate similarly to load detector 712a.

Based on the above, a load detection system and method for tightening a fastener using a load detection system may allow an operator to accurately tighten a fastener to a predetermined tightness without the need to utilize a manual torque wrench. The load detection system and method may also allow for long-term monitoring of fasteners to ensure such fasteners remain sufficient tight. Furthermore, the system may be applied to conventional impact wrenches without the need for a specialized tool because the load detector is built into the fastener. Furthermore, an accuracy of the tightness of the fastener may be increased because the load is based on the strain within a shank of the fastener itself and not based on an applied external torque to the fastener. Additionally, because the use of a torque wrench may be omitted, operator fatigue may be reduced, and safety may be increased. Accordingly, time, effort, safety, and accuracy of a tightening operation may be enhanced.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A load detection system comprising:
a fastener assembly comprising a load detector configured to detect a load applied to a shank of a fastener of the fastener assembly; and
a shut-off device that is communicatively coupled to the load detector of the fastener, the shut-off device being configured to shut off power to an impact wrench configured to tighten the fastener.

2. The load detection system of claim 1, wherein the shut-off device is configured to shut off power to the impact wrench based on the load detected by the load detector.

3. The load detection system of claim 2, wherein the shut-off device is configured to shut off power to the impact wrench when the load detected by the load detector is at or exceeds a predetermined threshold load.

4. The load detection system of claim 1, wherein the load detector comprises an integrated circuit having a transceiver configured to communicatively couple to an external device.

5. The load detection system of claim 4, wherein the transceiver is configured to communicatively couple to the external device via a wireless protocol.

6. The load detection system of claim 4, further comprising a computing device, wherein the load detector is communicatively coupled to the shut-off device via the computing device.

7. The load detection system of claim 6, wherein the load detector communicatively couples to the computing device based on a proximity of the computing device to the load detector.

8. The load detection system of claim 1, wherein the shut-off device comprises a valve that controls a flow of air from a compressed air supply to the impact wrench.

9. The load detection system of claim 8, wherein the shut-off device further comprises a valve controller operable to actuate the valve, the valve controller being communicatively coupled to the load detector.

10. The load detection system of claim 1, wherein the shut-off device comprises a switch that opens and closes a circuit providing electrical power to the impact wrench.

11. The load detection system of claim 1, further comprising a relay device configured to be installed on a socket, the socket being attachable to the impact wrench, the relay device being configured to relay a signal from the load detector within the socket to outside of the socket.

12. A method for tightening a fastener, the method comprising:
communicatively coupling a load detector positioned within a fastener assembly to a shut-off device;
tightening a fastener of the fastener assembly with an impact wrench;
monitoring a load on the fastener with the load detector; and
shutting of power to the impact wrench via the shut-off device when the monitored load is at or exceeds a predetermined threshold load.

13. The method of claim 12, wherein communicatively coupling the load detector to the shut-off device comprises communicatively coupling the load detector to a computing device and communicatively coupling the computing device to the shut-off device.

14. The method of claim 12, wherein shutting off power to the impact wrench comprises closing a valve to restrict air flow from a compressed air supply to the impact wrench.

15. The method of claim 12, wherein shutting off power to the impact wrench comprises opening a switch to shut-off electrical power to the impact wrench.

16. The method of claim 15, wherein monitoring the load of on the fastener comprises monitoring an output from a strain gauge disposed within a shank of the fastener.

17. The method of claim 12, further comprising monitoring the load on the fastener with the load detector after the fastener is tightened with the impact wrench.

18. A load detecting fastener comprising:
a shank;
a sensor configured to measure a load on the shank; and
an integrated circuit configured to receive an output of the sensor and output information based on the output of the sensor to an external device.

19. The load detecting fastener of claim 18, wherein the sensor comprises a strain gauge disposed within the shank.

20. The load detecting fastener of claim 19, wherein the strain gauge extends from a distal end of the shank to a head of the fastener.

21. The load detecting fastener of claim 18, wherein the integrated circuit comprises a near field communication chip that communicatively couples to an external device based on a proximity of the external device to the fastener.

22. The load detecting fastener of claim 18, wherein the integrated circuit comprises a BLUETOOTH communication chip that communicatively couples to an external device.
